(19) United States
(12) Patent Application Publication
(10) Pub. No.: US 2007/0061052 A1
(43) Pub. Date: Mar. 15, 2007

(54) Noise profiling for ignition sense

(75) Inventor: C.M. Wong, Ontario (CA)

Correspondence Address: JAMES ALAN FRANKLIN, 7901 RAVENSWOOD RD, GRANBURY, TX, 76049, US

(73) Assignee: MAGNADYNE CORPORATION, COMPTON, CA (US)

(21) Appl. No.: 11/154,125

(22) Filed: Jun. 15, 2005

(51) Int. Cl. G06F 17/00

(52) U.S. Cl. 701/1; 307/10.1

(57) ABSTRACT

A vehicle security and convenience system configured to sense and profile the electrical noise at the vehicle's electrical network. The system controller determining based on the noise characteristics whether or not the ignition is on and controlling the operational parameters of the system based on such determination.

### BACKGROUND

1. Field

The present invention relates generally to vehicle security and convenience systems.

2. Discussion of the prior art

One of the more significant contributions of vehicle security and convenience systems (hereafter “vehicle systems”) is the remote access to the vehicle and the ability to disable one or more of the normal operating functions, such as the ability to start or operate the vehicle. In an armed state, the prior art systems were designed to prevent the vehicles from starting when an unauthorized person engaged the ignition switch to its start position. To achieve this functionality, the prior art security systems placed a security controller, operable in communication with a remote control transmitter. The controller controlled the operation of a cutoff relay placed in between the ignition switch and the starter solenoid. The current path to the starter solenoid, normally completed by placing the ignition switch to the start position, was interrupted by the cutoff relay when the controller was in its armed state. Thus, the vehicle could not be started.

One of the other significant features of vehicle systems is the ability to passively arm the system. As an example, after the ignition key is removed, the door is opened and closed and the doors stay closed for some period of time, such as 30 seconds or a minute, the controller would automatically arm the vehicle system. Such arming ordinarily comprises controller sending a door lock signal and setting operational parameters to respond to one or more sensors that indicate a disturbance such as a shock sensor or a door pin. Such arming may also involve the effective start-disable routine, such as interfering with the current to the starter or one or more of other components normally used for normal operation of the vehicle.

Proper operation of such features and capabilities relies on knowing whether the ignition is on or off. Traditionally, this is accomplished by connecting to the ignition wire in the vehicle. The vehicle system controller relied on this signal to determine that the user turned on the ignition and based on that condition or operational parameter, the controller either stops or continues certain operations. Another example where ignition-on is used to set operational parameters is the arm lockout. It is undesirable to arm the vehicle system when the vehicle's electrical network it is operational. Namely, it is undesirable to interfere with the operation of the vehicle and it is undesirable to sound the alarm triggered by various sensors when the vehicle is in motion. Mentioned herein are two prominent examples. Other examples exist or may in the future exist to make operational decisions depending on whether or not the ignition is on or the vehicle's electrical system, i.e. its electrical network, is operating.

In the recent past the controller of vehicle systems has been miniaturized and it is now possible to replace an OEM relay, such as a starter relay with a pin compatible and functionally equivalent device that duplicates the OEM functionality and further incorporates many or all of the features that are provided in a vehicle system. Such replacements have significantly reduced the complexity, time and expense of installing vehicle systems, thereby expanding the marketability of such vehicle systems. With this technology an after market installer, with a relatively minimal effort, could install a vehicle system on a number of vehicles in a lot. The dealer then has an opportunity to sell the vehicle system to a buyer. In the event the buyer is unwilling to purchase the vehicle system, a lot attendant or sales person could simply unplug the security system and replace it with the OEM relay. Again, the expense of such installation and replacement is minimal as compared to similar activities of the recent past.

In the stride of simple and efficient installation, it is undesirable to locate and provide the traditional ignition on or off connection to the vehicle system, as it involves locating the ignition wire in the electrical system/network of the vehicle, tapping into the ignition wire and physically bringing the connection to the controller or processor of the vehicle system. Moreover, with the vehicle systems shrinking in size, less and less room is available for connections and bringing external connections is counterproductive to the simplicity and efficiency of quickly and simply installing and removing such vehicle systems. I.e. it would be significantly more involved and expensive to locate and install the ignitions wire to a system that is otherwise installed by replacing a single relay. Therefore, there is a need to determine whether the ignition is on, without tapping into the ignition connection of a vehicle and without bringing that signal to the controller of the vehicle system.

### SUMMARY

The disclosed device and method provide the functionality of tapping into and coupling to the ignition wire without the traditional necessity of tapping into the ignition wire of a vehicle system. To accomplish this challenge, the disclosed device and method monitor the voltage signal profile at an electrical connection normally available at a point of installation of a controller of a vehicle system and determining the electrical noise profile at that connection. Taking advantage of recognizing that more noise is present when the vehicle's electrical network is operational, which is a byproduct of the user turning on the ignition, the vehicle system can make operational decisions or set operational parameters, depending on whether or not the noise level reaches a threshold indicative of the network operating, thereby indicating that the ignition is on. Conversely, sensing a relatively quiet electrical network, i.e. where the electrical noise profile is less than a threshold, suggests that the vehicle system is connected to a relatively quiet, or non-operational network, i.e. when the network is connected to a DC battery with the ignition in its off-state.

Based on the noise level, which is compared by the vehicle system to a threshold indicative of operation of one or more electrical components in the vehicle's electrical network, where such components are normally operable when the ignition is on, the vehicle system uses the noise measurement that is above a threshold to assume that the ignition is on and therefore set one or more of the operational parameters. As described above, the vehicle system would not passively arm and/or fully actively arm, when a noise threshold is reached, indicating that the ignition is turned on.

### BRIEF DESCRIPTION OF THE DRAWINGS

FIG. 1 illustrates a block diagram of one of the embodiments of the vehicle system coupled to a vehicle's electrical network;

FIG. 2 illustrates a voltage/time diagram showing a typical voltage profile at a point DC-coupled to a vehicle's electrical network;

FIG. 3 illustrates an AC component of the electrical profile at a point AC-coupled to a vehicle's electrical network.

FIG. 4 illustrates a flowchart of a method of detecting noise indicative of operation or non-operation of a vehicle;

FIG.5 is an alternate block diagram of the embodiment shown in FIG. 1.

### DETAILED DESCRIPTION

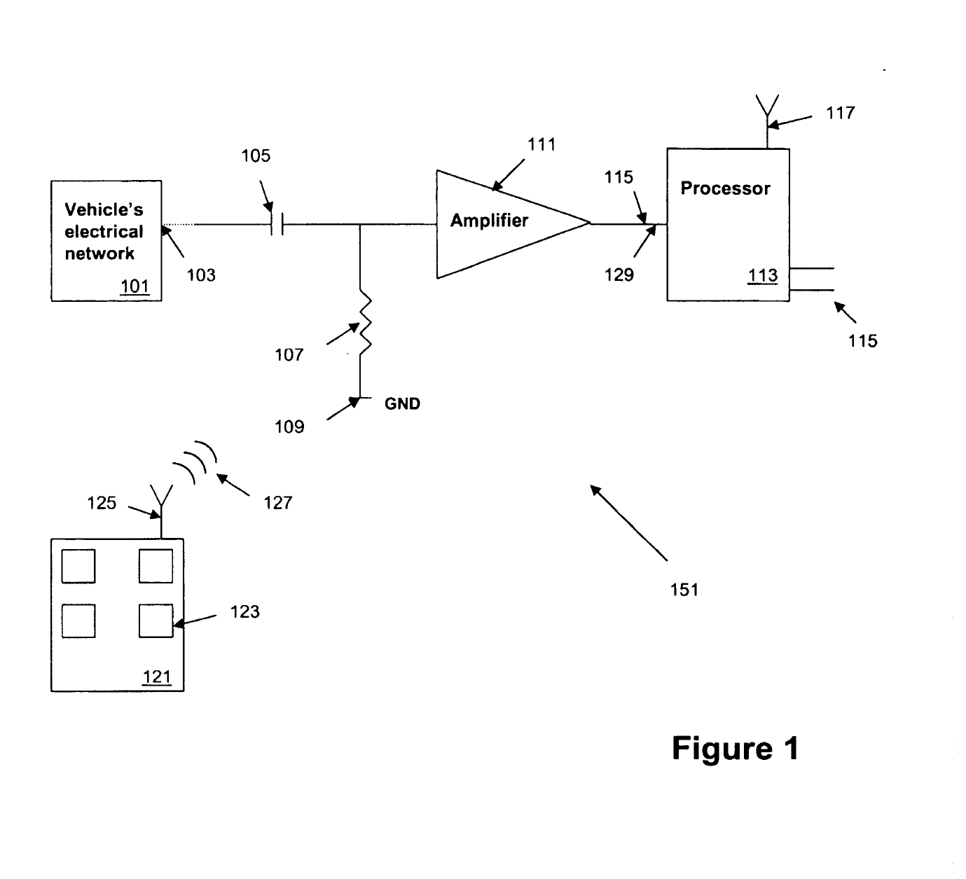

Shown in FIG. 1 is a block diagram of one of the embodiments of a vehicle system 151 connected to a vehicle's electrical network 101 at a point 103. Network 101 is shown generally and comprises, but is not limited to the electrical components, wiring and harnesses, vehicle's battery, its generator, and one or more processors of a vehicle.

The disclosed embodiment further compromises a processor 113 having input and output lines 115. Although a processor block 113 is provided for illustration purposes, one of ordinary skill in the art will understand and appreciate that the processing and decision functions in this disclosure may be accomplished in a number of ways, including without limitation, in a device 113 constructed of logic gates, transistors, a processor and software—as one or in combination of two or more. Such one or more alternate structures will be hereafter referred to as “controller” 113. However, for simplicity, the disclosure herein is provided in view of one of such controller 113 structures, processor 113.

Processor 113 serves as a controller of vehicle system 151. Processor 113 could be coupled to vehicle's electrical network 101 vis-a-vis input/output line(s) 115, including in some applications vis-a-vis the vehicle's electrical bus (not shown), and control a number of vehicle's functions such as (1) the ability to interrupt normal operations of the vehicle, i.e. the ability to start or continue operation of a vehicle; (2) locking/unlocking the doors of a vehicle, windows, and comfort settings; (3) control audio and/or visual indicators such as a horn, siren and/or lights. With continued integration and miniaturization of logic devices, more and more functionality is provided in such processors 113.

Typically processor 113 operates in combination with one or more remote transmitters 121. Transmitter 121 typically comprises one or more control switches 123 that control one or more of the functions described above. For example, activating a switch 123 would initiate a signal 127 via antenna 125 that when in range, would be received by antenna 117 coupled to processor 113. Part of vehicle system 151 is a decoder (not shown) that decodes signal 127 into a series of bits comprising an authorization code and a control code. The authorization code is checked by processor 113 to confirm that it is a transmitter 121 that it should be responding to. Technology allows such functional blocks to be ever smaller and smaller and it is possible to provide them as stand alone silicon devices or an integral part of processor 113.

To expedite and simplify the installation and removal of vehicle systems 151, processors 113 are configured and integrated with a relay (not shown) in a pin configuration compatible physically and functionally to one of the relays in a vehicle, such as the starter enable relay (not shown). This allows an installer to unplug such relay and replace it with vehicle system 151 that is plug-in compatible and functionally compatible with the OEM relay and further comprises processor 113. (Although described in this functionally compatible embodiment, stand alone embodiment is also possible.) Yet in another embodiment, vehicle system 151 further provides an additional relay (not shown) in series with the OEM relay functionality, thereby providing additional security without compromising the integrity of such OEM system. In this structure, if the added relay of vehicle system 151 fails, vehicle's functionality is not compromised.

In such miniaturized systems 151, there is less and less room for input connections. Also, market economics require less and less time to correctly install vehicle systems 151 and as importantly, the ability to quickly and simply disable or remove vehicle systems 151 if the customer is not willing to purchase it. To maximize the integrity of the vehicle system 151 and the efficiency of its installation or removal, it is desirable to eliminate as many connections to processor 113 as possible. As described above, one of such connections is ignition-sense, which as described above gates at least one of the operational parameters of processor 113, such as passive arming that automatically arms the vehicle after the ignition is turned off. In this state, processor 113 arms automatically after a designated period of time, which is typically between 30 seconds and two minutes, although any period of time could be designated. Other functions are also contingent on knowing whether or not the ignition is on or off.

To eliminate the connection to the ignition wire of a vehicle to processor 113, the described device monitors the noise profile of vehicle's electrical network 101. Typically, more functional components of vehicle's electrical network 101 operate when the ignition is on. As they operate, one or more of them typically generates electrical noise, contributing to the noise profile of network 101. Therefore, if the noise profile can be categorized as having an off state and an on state, and processor 113 is configured to monitor such noise profiles, it could determine whether the ignition is on or off.

To facilitate this approach, processor 113 is coupled to the vehicle's electrical network 101 at 103. Such points of connection 103 are readily available throughout the vehicle. Because electrical noise is difficult to remove, it permeate at some level throughout all or most of network 101. As mentioned above, if the noise level is low, it is indicative of ignition in its off state. If on the other hand it is high, it is indicative of ignition in its on state. By being connected to network 101, processor 113 vis-a-vis its sensing capability can measure the noise level and determine based on pre-programmed or field-determined thresholds, whether the noise level is above or below a threshold, indicating whether the ignition is on or off.

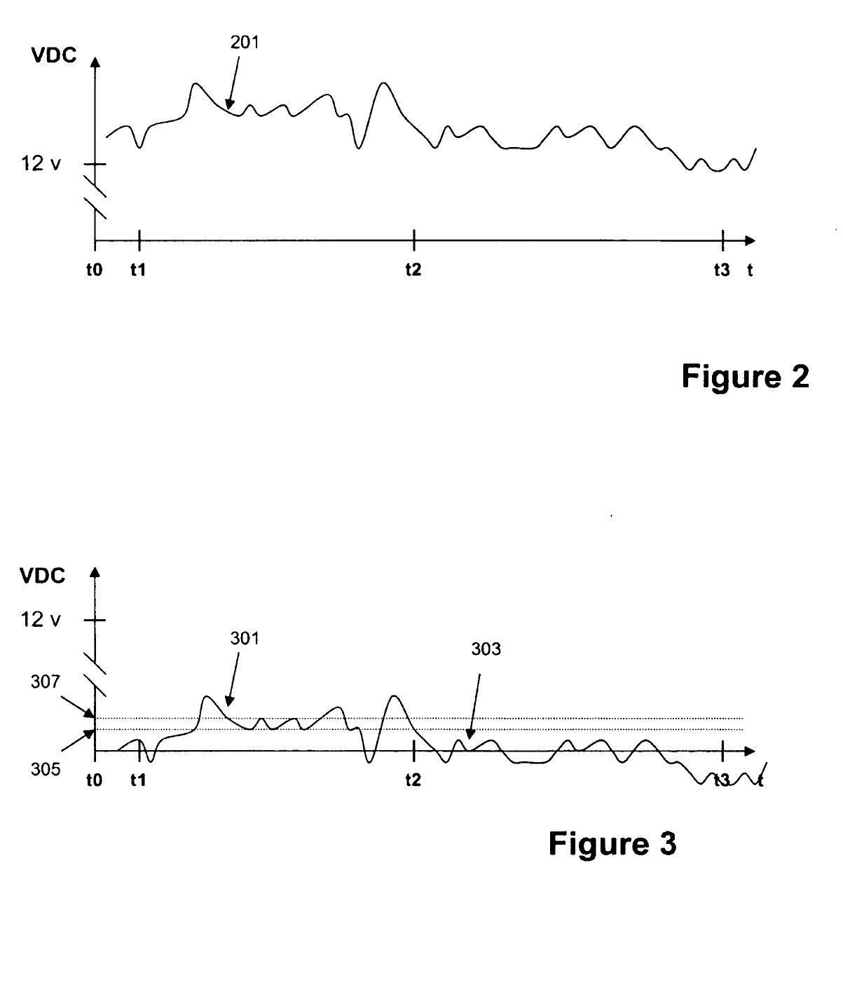

As will be described below in association with FIGS. 2 and 3, to facilitate such determination, it is desirable to first remove the DC component of the signal at point 103. In one embodiment, this is accomplished by conditioning the signal through a RC network of capacitor 105 and resistor 107 and grounding it at 109. This RC network blocks the DC component from amplifier 111. The AC component, such as the noise component is then brought to an amplifier 111 that amplifies the AC component and brings it to processor 113 at point 129 by means of one of its input lines 115. On board of processor 113 (or in another embodiment as an off-board circuit) is a sensing circuit, such as an analog to digital converter (“ADC”) that digitizes or measures the AC component representing the noise component of the signal at point 103.

FIG. 2 illustrates a representative voltage signal at point 103 together with its DC and AC component. Although illustrated in exaggeration, the reader will observe that the signal 201 is generally above the 12 Vdc level and it has some aberrations representing a cumulation of environmental noise, operational noise and DC voltage provided either by the battery or the electricity generator.

FIG. 3 illustrates a representative AC component of the signal illustrated in FIG. 2, at point 103, provided to processor 113 at point 129, after the DC component of the signal is grounded to 109 through the capacitor 105 and resistor 107. As seen in both FIGS. 2 and 3, and more clearly in FIG. 3, the noise has positive and negative AC aberrations, which over time average to zero. The illustrated signal in FIG. 3, however, indicates that the snapshot in time from t1 to t2 has noise characteristics rising above threshold 305. This indicates that the electrical network is on, in which case it follows that the ignition is on. In the time period from t2 to t3, however, the AC aberrations are below the threshold 305. This is more indicative of lower, non-operational electrical noise levels in network 101, i.e. with the ignition off.

In one embodiment, the typical peak noise amplitude in a non-operational network 101 is likely to be in the range of −500 mV to 500 mV. Therefore the manufacturer, installer or user may preset the threshold slightly above that level to minimize false settings. However, in another embodiment such thresholds are field variable or programmable. In such embodiments, processor 113, either automatically or via a command from the user, senses the non-operational/ignition-off state noise level at 129 over a period of time to determine the threshold levels 305 and optionally sets a margin represented by the difference between 307 and 305 to minimize false alarms. In an alternate embodiment, user sends processor 113 a trigger or commands to enter a setup or initialization mode, and then processor 113 senses the noise levels at the non-operational state and/or operational state to set threshold points 305 and 307. In these embodiments, processor 113 tailors the settings to the vehicle in which it operates and the environment in which it operates and subsequently. The readjustment capability is helpful as the vehicle ages, or is operating in a noisy environment. For example, if processor 113 is initially set in a relatively low noise environment and is later brought to a relatively higher noise environment, next to a radio or a television broadcast tower as one example, system 151 may appear to malfunction because thresholds 305 and/or 307 are inconsistent with the environmental noise conditions. Similarly, as one or more electrical components ages, it may create more electrical noise and the non-operational noise threshold 305 and its margin 307 would need to be readjusted for proper operation.

Also recognized is that relying on such AC component reading at any one point of time could provide erroneous results. Therefore the described device and method monitor the noise readings over a period of time and aberrations are averaged out or discarded. To overcome the zeroing effect of noise, the described embodiment looks at the signal's absolute value over a period of time, such as ½ or 1 second. More particularly, processor 113 reads absolute values of the conditioned signal at 129 and averages such readings over a time period of 500 milli seconds, as an example. Disproportionally high aberrations could are discarded or averaged out. But, over the sample period, the noise value of environmental or non-operational state will be lower than that of an operational state, where additional electrical network components of 101 are operating and generating noise. In another embodiment processor 113 measures the operational signal at 129 and similarly averages it over a period of time using known averaging or statistical techniques. Thus, when processor 113 detects a higher noise level, i.e. one above threshold 305, or depending on the embodiment, higher than a second threshold level 307, it will assume that the noise is generated by one or more operational components of network 101 and therefore conclude that network 101 is on and ignition is on. Processor 113 will therefore follow and set its operational parameters consistent with the ignition on state. As an example, in such state processor 113 will not automatically arm the vehicle. If processor 113 consistently takes readings between the thresholds 305 and 307, this is indicative of the threshold set too low or too high. Therefore, processor 113 could be configured to provide a signal to the user or installer to reset the threshold or automatically adjust the it.

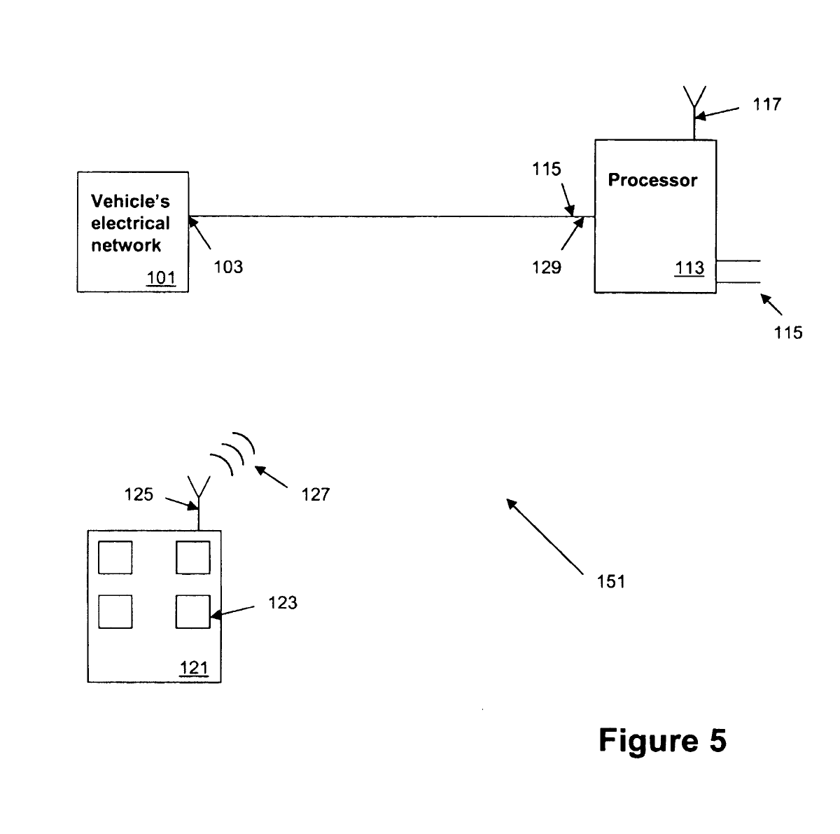

Yet in another embodiment, shown in FIG. 5, one could further utilize the available capabilities of processor 113 to process the signal at 103 and remove the DC component of that signal. As one example, network 101 signal could be digitized by on-board circuitry of processor 113 (or an off-chip ADC) and stored in a memory accessible to processor 113. Processor 113 samples the signal at 129 and isolates the AC component. As an example, processor 113 samples the signal at 129 and using signal processing techniques available in the art, substracts the DC component from the sampled DC+AC signal. This would leave processor 113 with the difference or AC component of the signal. Once the noise component is isolated, the above described techniques for determining the operational and non-operational states would similarly apply to this embodiment.

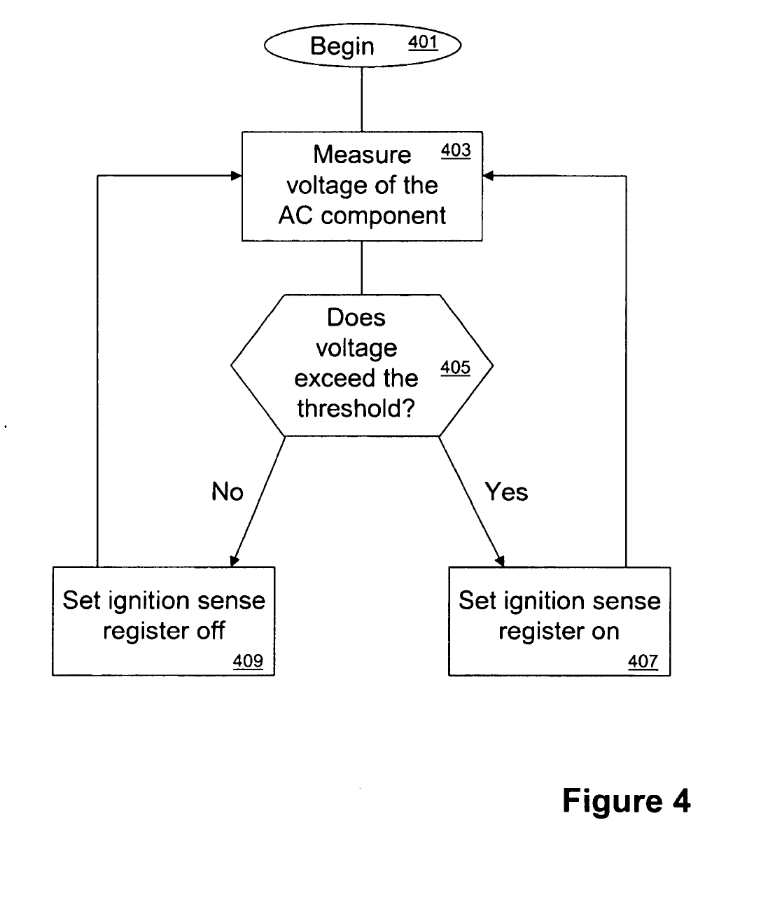

FIG. 4 illustrates a method beginning at 401. Processor 113 then extracts the AC component of signal at network 101 using its on-board analog to digital converter (not shown) or a similar device (not shown) residing outside processor 113. Using techniques described above at 405 a decision is made whether the AC signal or noise exceeds a threshold. If so, at 409 processor 113 sets or retains operational parameters consistent with the ignition-on condition and returns to 403 to monitor the noise conditions. If however, the AC signal or noise does not exceed the environmental noise threshold, at 407, processor 113 sets or retains operational parameters consistent with the ignition-off condition and returns to 403. This method could be practiced by individual vehicle owners, however, the claims herein, vis-a-vis the term “providing” is intended to also comprise those who design, manufacture, contract manufacture, import, export, install, distribute, sell, offer for sale or use such method and devices configured for its use.

The embodiments described above have been disclosed in view of general availability and flexibility of processors 113. However, it is to be understood that similar functionality could be achieved with dedicated logic circuits available in the art, or software applications executed on general or dedicated processors that reside in a vehicle. Although the examples have been described with processor 113 the use of such alternate embodiments alone or in combination are equally desirable and should are intended to be implied and covered by the term “controller” 113 in the accompanying claims. Similarly, the line between vehicle security systems and vehicle convenience systems is eroding. Therefore, as mentioned above, the term “vehicle systems” is intended to cover and capture both of such systems, whether with or without an alarm function and whether supplied as part of the vehicle or added on after the manufacture of the vehicle.

Also described herein are various embodiments to detect the AC component of the signal from vehicle electrical network 101. However, it is to be understood that similar functionality could be achieved with other AC detection/isolation circuits. As such, the term “detector” will be generically used in the accompanying claims. The use of the term “detector” is intended to cover and usurp such techniques, methods and structures that can extract the noise or AC component of a signal.

While the present invention has been described herein with reference to particular embodiments thereof, a degree of latitude or modification, various changes and substitutions are intended in the foregoing disclosure. It will be appreciated that in some instances some features of the invention will be employed without corresponding use of other features without departing from the spirit and scope of the invention as set forth.

1. A method for establishing at least one operational parameter in at least one controller configured for installation in a vehicle, the method comprising:
(a) sensing electrical noise level of an electrical network in said vehicle;
(b) determining if said electrical noise level exceeds a threshold indicative of operation of at least one electrical component of said vehicle normally operative when said vehicle's ignition is on; and
(c) establishing said at least one operational parameter of said controller based on whether said noise level exceeds said threshold.

2. The method of claim 1 wherein said at least one operational parameter comprises a parameter suspending passive arming if said noise level exceeds said threshold.

3. The method of claim 1 wherein said at least one operational parameter comprises a parameter enabling passive arming if said noise level is lower than said threshold.

4. The method of claim 1 wherein said at least one operational parameter comprises a parameter suspending said controller from responding to at least one sensor of said vehicle system if said noise level exceeds said threshold.

5. The method of claim 1 wherein said at least one operational parameter comprises a parameter allowing said controller to respond to at least one sensor of said vehicle system if said noise level is lower than said threshold.

6. A method for establishing at least one operational parameter in at least one controller configured for installation in a vehicle, the method comprising:
(a) configuring said at least one controller for sensing electrical noise level of an electrical network in said vehicle;
(b) configuring said at least one controller for determining if said electrical noise level exceeds a threshold indicative of operation of at least one electrical component of said vehicle normally operative when said vehicle's ignition is on; and
(c) configuring said at least one controller for establishing said at least one operational parameter of said controller based on whether said noise level exceeds said threshold.

7. A controller configured for use in a vehicle system, said controller comprising:
(a) a detector configured to detect at least one AC component of an electrical signal coupled to a vehicle's electrical network;
(b) said controller configured for coupling to said detector and configured to determine if said at least one AC component exceeds a threshold indicative of operation of at least one electrical component of said vehicle that is normally operative when said vehicle's ignition is on; and
(c) said controller configured to establish at least one operational parameter based on a comparison of said AC component and said threshold.

8. The vehicle system of claim 7 wherein said at least one AC component comprises a noise component.

9. The vehicle system of claim 7 further comprising a transmitter configured to remotely control said vehicle system.

10. The vehicle system of claim 7 further comprising a vehicle operationally connected to said vehicle system, wherein said controller is configured to control at least one of user controllable functions of said vehicle.

11. The vehicle system of claim 7 wherein said at least one operational parameter comprises a parameter allowing operation of a passive mode.

12. The vehicle system of claim 7 wherein said at least one operational parameter comprises a parameter suspending operation of a passive mode.

13. The vehicle system of claim 7 wherein said at least one operational parameter comprises a parameter enabling a mode wherein said controller is responsive to at least one sensor input coupled to said controller if said AC component is lower than said threshold.

14. A controller configured for use in a vehicle system, said controller comprising:
(a) a detector configured to detect at least one AC component of an electrical signal coupled to a vehicle's electrical network;
(b) said controller connected to said detector and configured to determine if said at least one AC component exceeds a threshold indicative of operation of at least one electrical component of said vehicle that is normally operative when said vehicle's ignition is on; and
(c) said controller controlling at least one operational parameter based on a comparison of said AC component and said threshold.

15. A vehicle system comprising:
(a) at least one electrical component of a vehicle electrical network coupled to a controller;
(b) said controller configured to time average a voltage level at said at least one electrical component, thereby establishing a DC component of said voltage level;
(c) a comparator configured to provide an AC component by subtracting said DC component from said voltage level;
(d) said controller configured to determine if said AC component exceeds a threshold indicative of operation of at least one said electrical component; and
(e) said controller configured to control at least one operational parameter based on said AC component.

16. The vehicle system of claim 15 wherein said AC component comprises a noise component.

17. The vehicle system of claim 15 further comprising a transmitter configured to remotely control said vehicle system.

18. The vehicle system of claim 15 further comprising a vehicle operationally connected to said vehicle system, wherein said controller is configured to control at least one of user controllable functions of said vehicle.

19. The vehicle system of claim 15 wherein said at least one operational parameter comprises a parameter allowing operation of a passive mode.

20. The vehicle system of claim 15 wherein said at least one operational parameter comprises a parameter suspending operation of a passive mode.

21. The vehicle system of claim 15 wherein said at least one operational parameter comprises a parameter enabling a mode wherein said controller is responsive to at least one sensor input coupled to said controller if said AC component is lower than said threshold.

22. A vehicle system comprising:
(a) at least one electrical component of a vehicle electrical network coupled to a controller;
(b) said controller averaging a voltage level at said at least one electrical component, thereby establishing a DC component of said voltage level;
(c) a comparator providing an AC component of said voltage level by subtracting said DC component from said voltage level;
(d) said controller configured to determine if said AC component exceeds a threshold indicative of operation of at least one said electrical component; and
(e) said controller controlling at least one operational parameter based on said AC component.
